(19) United States
(12) Patent Application Publication
(10) Pub. No.: US 2026/0172886 A1
(43) Pub. Date: Jun. 18, 2026

(54) ENHANCED MANAGEMENT OF LOW LATENCY TRAFFIC CHANNEL ACCESS IN WLAN SYSTEMS

(71) Applicant: INTERDIGITAL PATENT HOLDINGS, INC., Wilmington, DE (US)

(72) Inventors: Hanqing LOU, Syosset, NY (US); Xiaofei WANG, North Caldwell, NJ (US)

(21) Appl. No.: 18/980,389

(22) Filed: Dec. 13, 2024

(51) Int. Cl. H04W 28/02; H04W 84/12

(52) U.S. Cl. CPC H04W 28/0247; H04W 28/0268; H04W 84/12

(57) ABSTRACT

Methods and apparatuses are disclosed for a station (STA) in a Wireless Local Area Network (WLAN) to indicate its intent to transmit high priority traffic, such as low latency traffic, over a shared wireless medium. Multiple embodiments for the transmission by a STA of a signal referred to as a Low Latency Traffic Indication (LLTI) as well as low latency traffic are disclosed. An Access Point (AP) manages the conditions subject to which STAs may transmit the LLTI and contend for the wireless medium for the purpose of transmitting low latency traffic. Various procedures for negotiating said conditions between an AP and a STA are also disclosed. Multiple embodiments of methods and apparatuses are disclosed.

### CROSS-REFERENCE TO RELATED APPLICATIONS

This application is related to U.S. patent applications Ser. Nos. 18/632,118 and 18/632,123, both filed Apr. 10, 2024, and both incorporated herein by reference in their entireties.

### BACKGROUND

A wireless local area network (WLAN) in Infrastructure Basic Service Set (BSS) mode has an Access Point (AP) for the BSS and one or more stations (STAs) associated with the AP. The AP typically has access or interfaces to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA. For certain kinds of traffic, referred to herein as “low latency traffic,” such as traffic for which it may be necessary or desirable to meet, for example, certain maximum delay and/or jitter requirements, it may be desirable to adopt latency management features in a WLAN.

### SUMMARY

One or more of the foregoing issues or needs may be addressed by aspects of the embodiments disclosed herein.

In certain aspects, embodiments of a method are disclosed for a station (STA), the method comprising: transmitting, to an access point (AP), a request regarding one or more conditions for managing low latency traffic access to a wireless medium in a wireless local area network (WLAN); receiving, from the AP, a response including management information relating to the one or more conditions; and accessing the wireless medium in accordance with the management information.

In certain aspects, embodiments of a station (STA) are disclosed comprising a transceiver and a processor communicatively coupled to the transceiver, the transceiver and processor configured to: transmit, to an access point (AP), a request regarding one or more conditions for managing low latency traffic access to a wireless medium in a wireless local area network (WLAN); receive, from the AP, a response including management information relating to the one or more conditions; and access the wireless medium in accordance with the management information.

Additional aspects are also disclosed.

One or more embodiments also provide a computer program comprising instructions which when executed by one or more processors cause the one or more processors to perform the methods according to any of the embodiments described herein.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of an example wireless local area network (WLAN) in which one or more disclosed embodiments may be implemented;

FIGS. 3A and 3B show an example of a low latency traffic indication (LLTI) element used in a WLAN;

FIGS. 4A and 4B show exemplary formats of LLTI Request and Response frames used in an exemplary LLTI negotiation procedure;

FIG. 5 illustrates an exemplary LLTI negotiation procedure;

FIG. 6 illustrates an exemplary LLTI negotiation procedure using Stream Classification Service (SCS) frames;

FIG. 7 illustrates an exemplary Low Latency (LL) Score assignment procedure;

FIG. 8 illustrates an exemplary Low Latency (LL) Score assignment procedure;

FIG. 9 illustrates an exemplary mapping of LL scores to LLTI channel access parameters; and

FIG. 10 illustrates an exemplary procedure for an Access Point (AP) to indicate start and end times for LLTI channel access.

### DETAILED DESCRIPTION

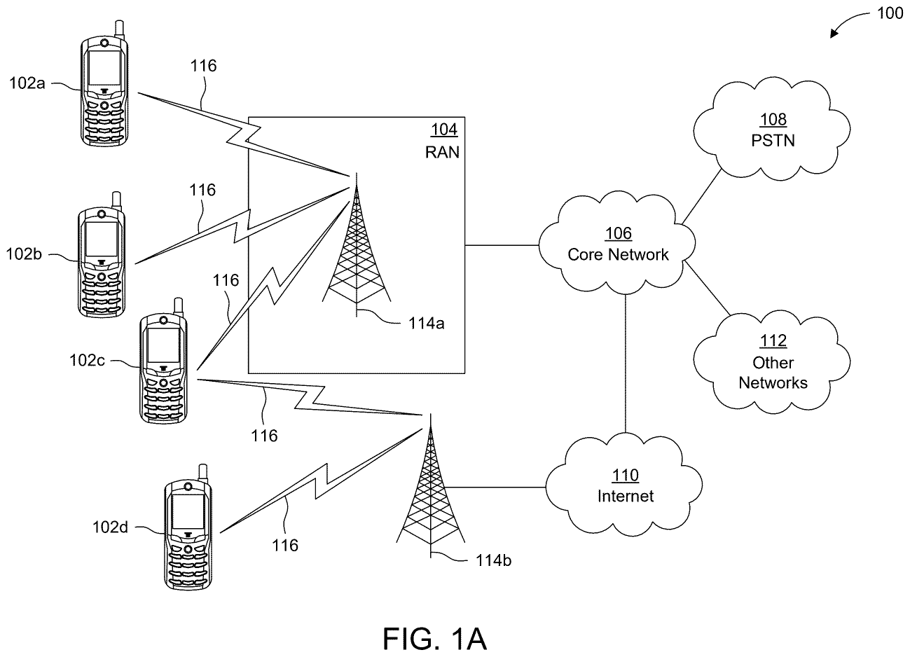

The methods, apparatuses and systems provided herein are well-suited for communications involving both wired and wireless networks. An overview of various types of wireless devices and infrastructure is provided with respect to FIGS. 1A-1D, where various elements of the network may use, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may use multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface used by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may use any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may use a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUS 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may use beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may use one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being used by WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be used in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain exemplary embodiments that such a terminal may use (e.g., temporarily or permanently) wired communication interfaces with the communication network.

In exemplary embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain exemplary embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain exemplary embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other exemplary embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHz, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

### Low Latency Traffic Channel Access

According to existing channel access procedures, IEEE 802.11 stations (STAs) usually perform a random backoff procedure before transmitting for each contention period.

When a STA with a frame queued for transmission determines that the wireless medium is idle and the wireless medium remains idle for a period of a Distributed Inter-Frame Space (DIFS) or an Extended Inter-Frame Space (EIFS) from the end of the immediately preceding medium-busy event, the STA may invoke a random backoff procedure. The STA may start transmitting if the wireless medium remains idle after a backoff counter at the STA that is set to a randomly chosen initial value decrements down to 0. The backoff counter is set to an integer value chosen randomly with a uniform distribution between 0 to CW[AC], where CW is an integer value between aCWmin and aCWmax, and AC is an index corresponding to an access category (e.g., voice, video, best effort, background). aCWmin and aCWmax are values set by the AP. The STA (AP or non-AP) will set the initial value of CW to aCWmin. CW is doubled when a collision or transmission failure occurs but is capped by aCWmax. CW is reset to aCWmin after every successful transmission. If no medium activity is indicated for the duration of a particular backoff slot, then the backoff procedure shall decrement its backoff counter.

To support low latency traffic transmission, one approach is to allow STAs with low latency traffic to transmit a Defer Signal (DS) without backoff in a contention period. After receiving a DS, STAs without low latency traffic are expected to hold their contention and wait for the next transmission opportunity (TXOP). Meanwhile, the STAs that have just transmitted the DS may start a backoff procedure to contend for access to the channel in order to transmit their low latency traffic. This backoff procedure reduces the chance of transmission collision among the STAs with low latency traffic. Also, for such STAs, the contention window value CW may be smaller than those for legacy STAs or STAs without low latency traffic.

A purpose of the Defer Signal (DS), or the like, is to give STAs with low latency traffic a chance to access the medium in an aggressive way, in that the DS is transmitted without backoff. Any aggressive STA, however, regardless of the type of traffic (low latency or not) it may have, can always transmit the DS at the beginning of a contention period. If there is one such aggressive STA in a BSS, it will always be able to occupy the medium whenever it wants. If there is a group of such aggressive STAs in a BSS, this group of STAs will always have a higher priority to access the medium than the other STAs in the BSS. If all the STAs in a BSS are aggressive STAs, then the situation is like traditional channel access, except that the DS is always transmitted, unnecessarily, and becomes an additional overhead for any contention period. Therefore, to give STAs with low latency traffic high priority to access the medium by using a DS, or the like, while still maintaining a certain degree of fairness among STAs in the network and preventing intentionally aggressive STAs from occupying the channel unnecessarily, there is a need for improved mechanisms of managing channel access for high priority traffic, such as low latency traffic.

### Enhanced Low Latency Transmission Management

In a WLAN, it may be desirable that a STA with low latency traffic enjoy enhanced or higher priority access to the wireless medium than a STA without low latency traffic. In exemplary embodiments in accordance with the present disclosure, a STA with low latency traffic can transmit such traffic with limited or no backoff by first transmitting a signal referred to herein as a Low Latency Traffic Indication (LLTI), LLTI signal, or LLTI frame.

More than one STA may transmit an LLTI concurrently. The LLTI may be transmitted with no or limited backoff. Limited backoff may entail using a backoff procedure with higher priority, and/or a lower backoff counter, etc. After the LLTI is transmitted, STAs which have low latency traffic and/or had transmitted the LLTI may be able to contend for the wireless medium. After transmission of the LLTI, a STA may perform a backoff procedure, in which it randomly determines a backoff period, senses the wireless medium for any transmission activity thereon, and if in that backoff period does not sense any such activity, may then proceed to transmit its low latency traffic on the wireless medium.

A STA without low latency traffic or which has not transmitted the LLTI may withhold transmission after detecting transmission of an LLTI from other STA(s). For example, after it detects an LLTI, a STA without low latency traffic may defer its channel access.

The aforementioned procedures may be allowed in a certain period of time or duration, such, as for example, within a TXOP, within a beacon interval, or for any contention period, which may be determined dynamically or semi-statically.

Exemplary channel access schemes described herein may be referred to as LLTI transmission or LLTI channel access schemes, with the procedures mentioned above being examples thereof. In general, LLTI channel access or LLTI transmission schemes such as disclosed herein may be referred to as enhanced channel access schemes, providing channel access which is enhanced relative to conventional CSMA/CA channel access.

Measures and procedures, as disclosed in greater detail herein, may be used in such schemes to prioritize channel access and to minimize the possibility of collisions of LLTI transmissions from multiple STAs.

For example, after the transmission of a first LLTI, each transmitting STA may pick a random number as the initial value of an LLTI backoff counter. After the LLTI backoff counter of such an STA has expired and if the STA had not detected any transmission or energy greater than a predefined LLTI Clear Channel Assessment (CCA) threshold during the STA's backoff time, the STA may transmit the LLTI again. If, however, the STA detected energy greater than the LLTI CCA threshold during its backoff period, the STA may hold its LLTI transmission and any other potential transmissions. This process may be repeated several times to further reduce the chance of LLTI collision. The number of LLTI repetition transmissions may be predefined or signaled as LLTI Repetition Times.

In exemplary embodiments, the LLTI may be a newly defined PPDU or a newly defined MAC frame. In one method, the LLTI signal may reuse existing MAC frame, such as RTS frame, CTS frame, CTS-to-Self frame etc. See, e.g., U.S. patent application Ser. No. 18/632,118, filed Apr. 10, 2024 and incorporated herein by reference in its entirety.

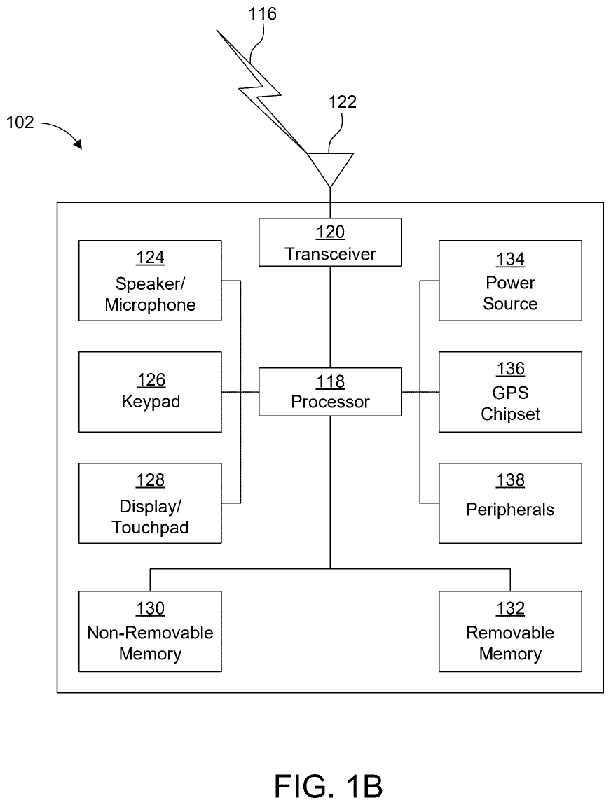

FIG. 2 shows an example WLAN 200 including a STA 202, a STA 206, a STA 208, and an AP 210. The WLAN 200 is in Infrastructure Basic Service Set (BSS) mode, with the STAs 202, 206, and 208 and the AP 210 considered to constitute a BSS. In the illustrative scenario depicted in FIG. 2, the STA 202 has transmitted a LLTI frame 204 to indicate its need to transmit low latency traffic and to inform non-low-latency transmitting STAs to defer transmission of their traffic. Transmission of the LLTI frame 204 is based on an LLTI management element 205 received from, for example, AP 210. LLTI management element 205 provides one or more conditions for managing the transmission of low latency traffic by facilitating and managing the transmission of the LLTI frame 204. Representative contents of the LLTI management element 205 are described in greater detail below.

### The LLTI Management Field/Subfield/Element

In exemplary embodiments in accordance with the present disclosure, a new LLTI management field/subfield/element to carry LLTI-related information is provided. Methods for restricting potentially improper use of the LLTI using such LLTI-related information are described further below.

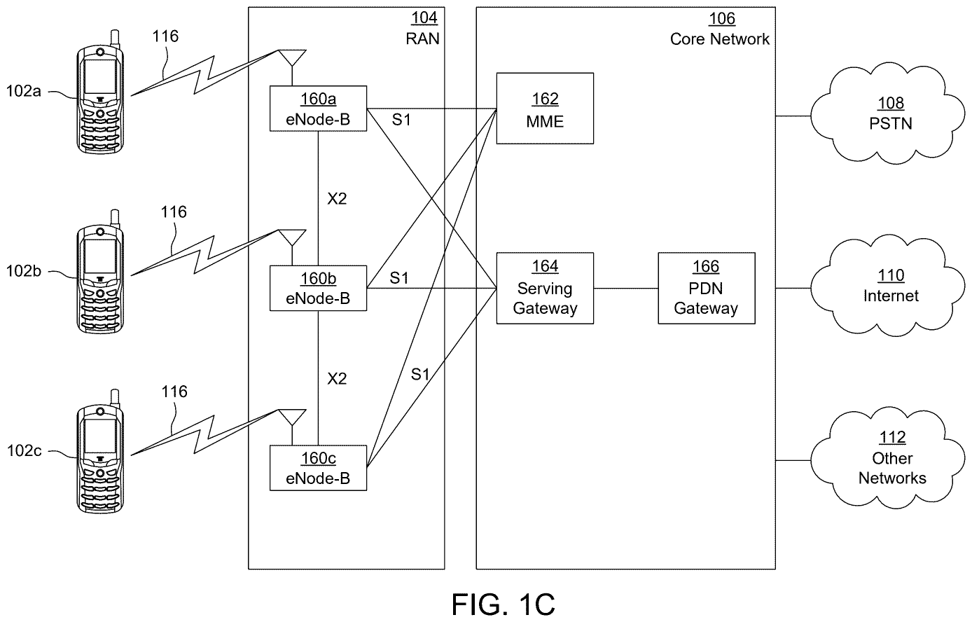

A representative LLTI management element 300 is shown in FIGS. 3A and 3B, having one or more subsets or all of multiple fields 302-340, which will now be described in greater detail. LLTI management element 300 can act as LLTI element 205 transmitted from AP 210, as depicted in FIG. 2.

An Element ID field 302 may be used to indicate that the element is an LLTI management element, a Length field 304 may be used to indicate the length of the LLTI management element 300, and an Element ID Extension field 306 may be used to indicate additional information about the LLTI management element 300.

A Type field 308 may be used to indicate whether the LLTI element 300 represents a request, a response, an update, or a termination of LLTI parameters, such as in an LLTI negotiation procedure described in greater detail below. For example, Type field 308 may be set to REQUEST to indicate that the LLTI element 300 (which may be carried, for example, in a Request frame sent by a STA (e.g., a non-AP STA) to another STA (e.g., an AP) in an LLTI negotiation procedure described below) contains LLTI parameters newly requested or suggested (e.g., by the STA to the AP). Type field 308 may be set to UPDATE to indicate that the LLTI element 300 contains suggested updated LLTI parameters that have been updated relative to an existing set of requested of LLTI parameters. Type field 308 may be set to RESPONSE to indicate that the LLTI element 300 (which may be carried, for example, in a Response frame sent from an AP to a STA) contains LLTI parameters to be used in LLTI channel access. Type field 308 may be set to TERMINATION to indicate that the LLTI element 300 pertains to an existing set of LLTI parameters whose use has been terminated.

A Status field 309 may be used to indicate the status of the LLTI parameters in the element 300. The value of Status field 309 may be set to SUGGEST, DECLINE, ACCEPT, MODIFY, or REMOVE. As an example, when Type field 308 is set to REQUEST or UPDATE, Status field 309 may be set to SUGGEST or REMOVE to indicate that the LLTI parameters carried in the element 300 are suggested parameters or that the element 300 pertains to an existing set of LLTI parameters to be removed. When Type field 308 is set to RESPONSE, Status field 309 may be set to ACCEPT, DECLINE, MODIFY, or REMOVE to indicate whether the suggested LLTI parameters carried in the LLTI Request frame are accepted, declined, modified, or removed, respectively, by the responder. In this case, when Status field 309 is set to MODIFY, the LLTI parameters carried in the LLTI Response frame may be the modified parameters set by the LLTI responder. In one example, Status field 309 may be reserved when Type field 308 is set to REQUEST or UPDATE. Status field 309 may be valid when element 300 is transmitted by a responder or an AP. The value carried by Status field 309 may indicate if the responder has suggested, declined, accepted, modified, or removed the LLTI parameters to which the element 300 pertains.

An LLTI Parameters field 310 may include LLTI parameters in multiple subfields, which will now be described with reference to FIG. 3B. In exemplary embodiments, LLTI Parameters field 310 may include all or a subset of the fields shown in FIG. 3B, such as for example, LLTI Channel Access Parameters field 322 and/or Traffic Information field 324, described below.

An LLTI ID field 312 may be used to identify the set of LLTI parameter values carried in LLTI Parameters field 310. A set of LLTI parameter values can thus be efficiently communicated, for example, by providing the value of the LLTI ID field 312 instead of the parameter values identified thereby.

An LLTI Mode field 314 may be used to indicate one or more scenarios or modes in which an LLTI (such as represented by LLTI frame 204 shown in FIG. 2) may be allowed to be transmitted. For example, Mode 1 may indicate that the LLTI may be transmitted in a TXOP. Mode 2 may indicate that the LLTI may be transmitted in a TXOP initiated by the AP. Mode 3 may indicate that the LLTI may be transmitted in any contention period, etc. In the case that only one mode is allowed, this field may be omitted, and the mode may be predefined.

A Maximum number of LLTIs per Beacon Interval (BI) field 316 may be used to indicate the maximum number of LLTIs (e.g., 0, 1, 2, . . . ) allowed per STA, per beacon interval. In exemplary embodiments, different Access Categories (ACs), Traffic Identifiers (TIDs), or other types of traffic priority categories may have different maximum allowed numbers of LLTIs per BI. In such a case, multiple values, each corresponding to a traffic priority category, may be included in this field.

A Maximum number of LLTIs per TXOP field 318 may be used to indicate the number of LLTIs allowed per STA per TXOP. In exemplary embodiments, different ACs, TIDs, or other types of traffic priority categories may have different maximum allowed numbers of LLTIs per TXOP. In such a case, multiple values, each corresponding to a traffic priority category, may be included in this field.

A field 320 containing a Minimum LLTI Interval may be used to indicate the minimum interval required between two consecutive LLTIs transmitted from a STA, or a non-AP STA. In exemplary embodiments, different ACs, TIDs, or other types of traffic priority categories may have different minimum LLTI interval requirements. In such a case, multiple values may be included in this field, with each value corresponding to a traffic priority category.

An LLTI Channel Access Parameters field 322 may include one or more subfields with parameters that may be used for LLTI channel access, such as for example:
LLTI Repetition Times: this subfield may indicate the number of LLTI transmissions before the STA may gain the wireless medium;
LLTI CCA Threshold: this subfield may indicate the threshold for the STA to determine if the wireless medium is busy for LLTI transmission; the LLTI CCA threshold may be different from the conventional CCA threshold; and/or
LLTI Random Backoff Range: this subfield may indicate a LLTI Random Backoff Range within which an initial value of a LLTI random backoff counter may be randomly chosen. For example, the LLTI Random Backoff Range may be determined by two numbers, an LLTI Backoff Window Minimum Value and an LLTI Backoff Window Maximum Value, such that, LLTI Backoff Window Minimum Value<=LLTI random backoff counter initial value<=LLTI Backoff Window Maximum Value.

A Traffic Information field 324 may be used to indicate that the LLTI parameter values are to be used or suggested for use by a specified type of traffic. Field 324 may indicate one or more Access Categories, TIDs, and/or SCSIDs of traffic for which the LLTI parameter values in field 310 are to be used or suggested. In exemplary embodiments, Traffic Information field 324 may carry one or more fields carried by a QoS Characteristics element, such as defined in IEEE P802.11be™/D7.0: Wireless LAN Medium Access Control (MAC) and Physical Layer h(PHY) Specifications, January 2023.

A Retry Allowed field 326 may be used to indicate if channel access by use of the LLTI is allowed for the first transmission, second transmission, up to a k-th transmission of a MAC packet, or any combination of the numbers [1, k] of transmissions, k being a maximum number of transmissions. This field may be in the form of a bitmap, for example, with each bit corresponding to a retry index, where the nth bit indicates if use of an LLTI is allowed for the (n−1)th transmission. As an illustrative example, a bitmap of 0010 indicates that an LLTI may be used for the third transmission, but it may not be used for the first, second, or fourth transmission of a packet. For those transmissions, channel access that does not use the LLTI may be used instead. Field 326 may also be in the form of a natural number, for example, m, where m indicates the use of an LLTI is only allowed for the mth transmission onwards after failing the first m−1 transmissions. The information in field 326 can be characterized as a type of priority information, which relates to conditions for which priority transmission, as described herein, may be available.

A Delay Bound field 328 may be used to indicate a threshold of delay bound of traffic for which channel access by use of the LLTI may be allowed, i.e., if a STA has traffic with delay bound smaller than the threshold, the STA may use the LLTI for transmission of its traffic. A special value in the Delay Bound field 328 may be used to indicate that no threshold is used and that use of the LLTI is allowed for traffic with any delay bound. The information in field 328 can be characterized as a type of priority information, which relates to conditions for which priority transmission, as described herein, may be available.

A Maximum LLTI TXOP Duration field 330 may be used to indicate the maximum allowed TXOP duration a STA could set after gaining access to the wireless medium using an LLTI. As used herein, “LLTI TXOP” refers to a transmission opportunity acquired through LLTI-based channel access. Setting this field to a special value (e.g., 0) may be used to indicate that there is no maximum duration limit for an LLTI TXOP. Alternatively, a Maximum LLTI PPDU Length/Duration field may be used instead of or additionally. Such a field may be used to indicate a maximum allowed LLTI PPDU length or duration. Setting this field to a special value (e.g., 0) may be used to indicate that there is no maximum PPDU limit for LLTI access.

A Periodic Low Latency Allowed field 332 may be used to indicate whether LLTI-based channel access is allowed and/or suggested for periodic low latency traffic. The information in field 332 can be characterized as a type of priority information, which relates to conditions for which priority transmission, as described herein, may be available. For example, under one condition, field 332 may indicate that LLTI-based channel access is permitted for periodic low latency traffic, while under another condition field 332 may indicate that LLTI-based channel access is permitted for only non-periodic low latency traffic. In some instances, field 332 may also indicate LLTI-based channel access allowance based a predefined threshold of how often periodic low latency traffic is available for transmission. If the periodic availability meets and/or exceeds said threshold, LLTI-based channel access is permitted.

A CWmin for Low Latency field 334 may be used to indicate an LLCWmin value to be used as the lower bound for an LLCW value for LLTI-based access. The LLCW value defines the range in which a STA may choose the backoff counter randomly. In other words, the STA may initialize an LL backoff counter with a randomly selected value in the range of [0, LLCW]. An STA may, for example, start with an LLCW value equal to LLCWmin, and, depending on the detailed channel access scheme, the STA may double or keep the LLCW value unchanged after a transmission failure. After a transmission success, the STA may reset the LLCW value to LLCWmin. In exemplary embodiments, different ACs, TIDS, or other types of traffic priority categories may have different LLCWmin values. In such a case, multiple values may be included in this field, with each value corresponding to a traffic priority category.

A CWmax for Low Latency field 336 may be used to indicate an LLCWmax value to be used as the upper bound for the LLCW value for LLTI-based access. In other words, the maximum value LLCW a STA could set is LLCWmax. In exemplary embodiments, different ACs, TIDs, or other types of traffic priority categories may have different LLCWmax values. In such a case, multiple values, each corresponding to a traffic priority category, may be included in this field.

In exemplary embodiments, the CWmin for Low Latency and CWmax for Low Latency fields 334 and 336, respectively, may contain the same value. In such a case, the LLCW value is set to this value and it is not adjusted based on transmission results (i.e., success or failure).

A User Priority field 338 may be used to indicate a priority threshold. A STA with user priority greater than this threshold may be allowed to transmit an LLTI. The information in field 338 can be characterized as a type of priority information, which relates to conditions for which priority transmission, as described herein, may be available.

A TXOP Threshold field 340 may be used to indicate a TXOP threshold value T. STAs may be allowed to transmit an LLTI within a TXOP when the TXOP duration is greater than T, as specified in this field.

While the representative LLTI management element 300 is described in the format of an element, the same or equivalent information described as included in LLTI management element 300 can be provided in any other suitable format, such as for example, in a sub-element, field, or subfield. Moreover, the various fields may be split and carried in multiple elements/fields/frames, and the LLTI information described may be carried in different elements, sub-elements, fields, subfields, and/or frames, and in different orders, structures, and/or arrangements.

The LLTI management element 300 may be carried in a management frame, such as for example, a Beacon frame, a Probe Response frame, a (Re)Association Response frame, etc.; in an existing or new action frame; or in an existing or new control frame.

In the case that multi-link operation is supported, an AP affiliated with an AP Multi-Link Device (MLD) (e.g., reporting AP) may announce the LLTI element for another AP affiliated with the same AP MLD (e.g., reported AP). To enable this, the LLTI element may be carried or included in an element, such as, for example, a Multi-Link element, an ML Re-configuration element, a Reduce Neighbor Report element, etc. A change in the LLTI element may cause an increase of the BSS Parameters Change Count subfield in the Beacon or it may cause the Critical Update Flag field in the Beacon to be set, thereby indicating that a critical update has happened for the corresponding reported AP.

### Restricting Potential Improper Use of the LLTI

In exemplary embodiments, the management of low latency transmissions may entail measures to minimize or avoid negative impacts for STAs that do not have low latency traffic or for STAs, such as legacy STAs, that may not transmit or fully understand the LLTI.

In exemplary embodiments, transmission of an LLTI may be restricted. For example, a STA may be allowed to transmit an LLTI up to N times per Beacon Interval, where N is a natural number (e.g., 1, 2, 3, . . . ). In exemplary embodiments, N may be predefined or it may be chosen by an AP and signaled through a broadcast frame, such as a Beacon frame, or through a frame during the association process. The number N can be indicated in the Maximum Number of LLTIs per BI field 316, described above with reference to FIG. 3B. As described above, different Access Categories (ACs), Traffic Identifiers (TIDs), or other types of traffic priority categories may have different values for N.

A STA may be allowed to transmit an LLTI up to M times per TXOP, where M is a natural number. In exemplary embodiments, M may be predefined or it may be chosen by an AP and signaled through a broadcast frame, such as a Beacon frame, or through a frame during the association process. The number M can be indicated in the Maximum Number of LLTIs per TXOP field 318, described above with reference to FIG. 3B. As described above, different values for M may be used for different ACs, TIDs, or other types of traffic priority categories.

A STA may be allowed to transmit an LLTI only after a certain time interval from its last successful transmission by use of an LLTI. The Minimum LLTI Interval field 320 shown in FIG. 3B may indicate the minimum interval required between two consecutive LLTIs transmitted from a STA, or a non-AP STA. In other words, a STA or a non-AP STA may need to wait at least the Minimum LLTI Interval from the end of its last LLTI transmission to transmit a new LLTI.

A STA may be allowed to transmit an LLTI if its low latency traffic meets certain requirements. For example, if the delay bound of a STA's low latency traffic is within a predefined period, or the length (in number of e.g., bits or bytes) of the low latency traffic is within a certain defined range, the STA may be allowed to transmit an LLTI. The Delay Bound field 328 described above with reference to FIG. 3B may indicate the delay bound threshold. If a STA has traffic for which the delay bound is less than the delay bound threshold, it may be allowed to transmit an LLTI.

A STA may be allowed to transmit an LLTI for the first transmission of its low latency traffic. A STA may be allowed to transmit an LLTI for the retransmission of its low latency traffic, such as indicated by the Retry Allowed field 326 of LLTI management element 300.

A STA with at least a minimum User Priority, such as indicated in field 338 described above, may be allowed to transmit an LLTI.

For a STA with periodic low latency traffic, other methods such as Target Wake Time (TWT) or restricted TWT (rTWT) may be suggested by the AP for delivery of the STA's traffic. Such a suggestion can be indicated in the Periodic Low Latency Allowed field 332, described above. In exemplary embodiments, STAs which support rTWT may not be allowed to transmit an LLTI within an rTWT service period. In one approach, no STAs are allowed to transmit an LLTI within an rTWT service period. In another approach, STAs which support rTWT may need to terminate their TXOP acquired by LLTI-based channel access before the rTWT service period.

STAs with low latency traffic that successfully acquire the wireless medium through use of an LLTI may need to have a limited TXOP duration. For example, the TXOP duration may be limited to a time T (where T can be expressed in units of microseconds, milliseconds, TUs, etc.) In exemplary embodiments, the value of T may be predefined or it may be indicated by the AP in a Beacon frame, Probe Response frame, (Re)Association Response frame, or other management/control frame. The time T can be indicated in the Maximum LLTI TXOP Duration field 330, described above with reference to FIG. 3B.

STAs may be allowed to transmit an LLTI at the beginning of a contention period, or they may be allowed to transmit the LLTI within TXOPs initiated by an AP. In the second case, the AP may transmit an initial control frame or an initial frame to start a TXOP. In the initial frame, the AP may indicate if an LLTI is allowed in the TXOP. In the initial frame, the AP may set the Duration field in the MAC header to cover the full TXOP duration. Or STAs may be allowed to transmit the LLTI within a TXOP (e.g., initiated by an AP) whose duration is greater than a threshold T (specified in units of microseconds, milliseconds, TUs, etc.) The threshold T may be predefined or indicated by the AP in a Beacon frame, Probe Response frame, (Re)Association Response frame, or other management/control frame. The threshold T can be indicated in the TXOP Threshold field 340, described above with reference to FIG. 3B.

In exemplary embodiments, a STA waking up from a power save or doze mode may need to wait for the reception of the LLTI-related information (e.g., the LLTI management element 300) before it may use the LLTI to acquire the channel.

### LLTI Parameter Negotiation

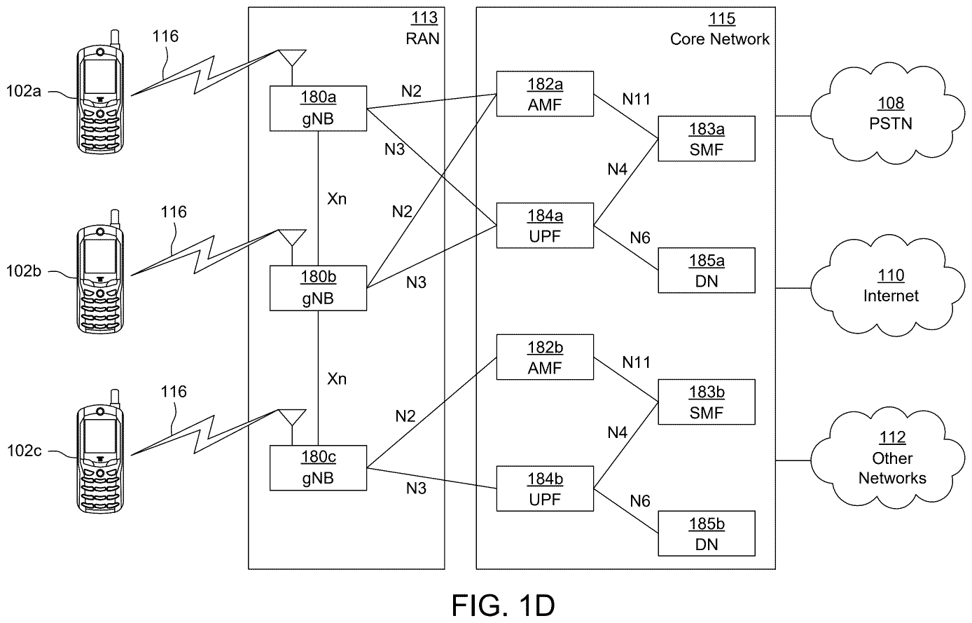

Exemplary embodiments of procedures for negotiating the parameters of LLTI channel access will now be described with reference to FIGS. 4-7. Generally, in exemplary such procedures, a STA with LL traffic will request, from an AP, LLTI channel access with a suggested set of LLTI parameter values, to which the AP will respond with an acceptance, denial, or modification thereof.

### LLTI Request/Response Action Frame Format

Referring to FIG. 4A, an exemplary LLTI Request/Response frame 400 that can be used in an exemplary LLTI parameter negotiation procedure is shown. Frame 400 may be a newly defined Action frame, a management frame, or a control frame which may carry one or more fields as defined in LLTI element 300 described above. An exemplary embodiment in which frame 400 is an Action frame will now be described.

As shown in FIG. 4A, exemplary LLTI Request/Response frame 400 may include a Category field 402 to indicate the category of the frame. A reserved value may be used to indicate that the frame is a UHR action frame.

A UHR Action field 404 may be used to indicate the UHR action frame type. In one example, a value (e.g., 1) may be used to indicate that frame 400 is an LLTI Request frame. A different value (e.g., 2) may be used to indicate that frame 400 is an LLTI Response frame.

A Dialog Token field 406 may be used to identify the request or response represented by the frame 400. Because an AP and a STA may exchange multiple LLTI Request/Response frames, the Dialog Token field 406 may be used to identify each request/response pair.

An LLTI element 410 may be included to carry LLTI-related parameters. An example of an element 410 may be all or part of an LLTI element 300, with LLTI-related parameters as described above with reference to FIGS. 3A and 3B. For an LLTI Request frame, the values of the LLTI-related parameters in element 410 are those LLTI parameter values suggested by the requester (e.g., non-AP STA) for use in LLTI channel access. For an LLTI Response frame, the values of the LLTI-related parameters in element 410 are those values agreed to or granted by the responder (e.g., AP).

A Quality of Service (QoS) Characteristic element 412, such as defined in IEEE P802.11be™/D7.0: Wireless LAN Medium Access Control (MAC) and Physical Layer h(PHY) Specifications, January 2023, may be included in frame 400. When included in an LLTI Request frame, element 412 can be used by the requester to indicate desired QoS characteristics for LLTI channel access. When included in an LLTI Response frame, element 412 can be used by the responder to indicate desired QoS characteristics for LLTI channel access.

In exemplary embodiments, other traffic-related element(s) or field(s) may be carried in an LLTI Request frame, such as for example, an SCS Descriptor element, TCLAS elements, TCLAS Processing Element, etc.

An LLTI Response frame may include a LLT Control field 418. An exemplary format of field 418 is shown in FIG. 4B. An LLTI ID subfield 422 is used to identify a set of LLTI parameter values (as described above with respect to LLTI ID field 312 of LLTI element 300) and a Status subfield 424 is used to indicate a response status associated with the set of parameter values identified in subfield 422. More specifically, in exemplary embodiments, Status subfield 424 may have a value of ACCEPT, DECLINE, or MODIFY to indicate whether the responder (e.g., AP) has accepted, declined, or modified the LLTI parameters requested by the requester (e.g., STA) in the LLTI Request frame to which the LLTI Response frame is responsive. It should be noted that the information in subfields 422 and 424 is the same as that in fields 312 and 309, respectively. In exemplary embodiments, any suitable combination of fields 309, 312, 422, and 424 may be included in an LLTI Response frame to convey said information.

### LLTI Negotiation Procedure Using LLTI Action Frames

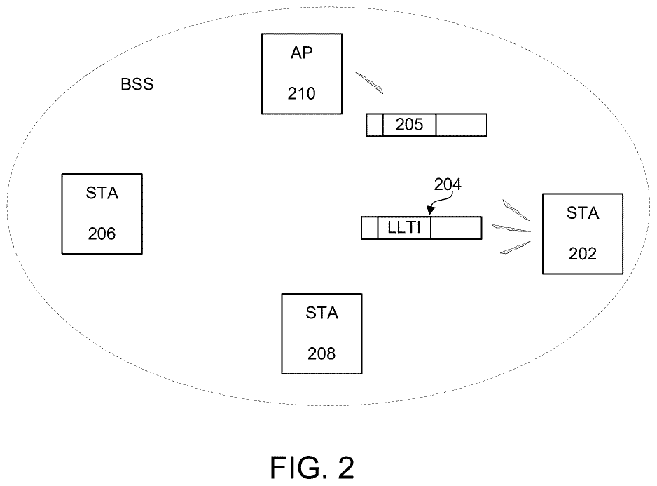

An exemplary LLTI parameter negotiation procedure using LLTI Request/Response frames such as described above will now be described with reference to FIG. 5.

In exemplary embodiments, a non-AP STA, STA1, may acquire the wireless medium, such as through CSMA/CA, EDCA, or any other suitable channel access method in accordance with WiFi standards. In exemplary embodiments, the non-AP STA1 may be polled or triggered by an AP to transmit on the wireless medium.

As shown in FIG. 5, STA1 transmits an LLTI Request frame 511 to its associated AP to request LLTI channel access for the traffic flow or SCS stream indicated in LLTI Request frame 511.

In exemplary embodiments, Type field 308 is set to REQUEST for a new LLTI parameter request. For the new request, an LLTI ID may be carried in the LLTI Request frame 511 to identify the set of LLTI parameter values requested. Type field 308 may be set to UPDATE for an LLTI parameter update. An LLTI ID may be carried (in field 312) in LLTI Request frame 511 to indicate the set of LLTI parameters to be updated.

LLTI Request frame 511 may carry all or part of LLTI element 300 to indicate the values of LLTI-related parameters suggested by the non-AP STA1 to the AP, which may be based on STA1's low latency traffic flow characteristics such as delay bound, jitter requirement, maximum MSDU size, service start time, service duration, service period, delay bounded burst size, minimum service interval, maximum service interval, etc. In exemplary embodiments, LLTI Request frame 511 may carry one or more of the aforementioned traffic flow characteristics.

In exemplary embodiments, LLTI Request frame 511 may carry QoS Characteristics element 412, an SCS Descriptor element, a TCLAS element, and/or one or more SCSIDs to identify one or more traffic flows or SCS steams. If the traffic flow or SCS stream parameters are carried in LLTI Request frame 511, the parameters are suggested to be applied to the traffic flow(s)/SCS stream(s) identified.

Responsive to reception of LLTI Request frame 511, the AP may transmit an LLTI Response frame 521 which carries LL TI element 300, or fields thereof. Type field 308 in the LLTI element may be set to RESPONSE. The parameters carried in LLTI Response frame 521 may be the parameters granted by the AP and may be used for the upcoming LLTI transmission. LLTI Response frame 521 may also carry a Status field 309 and/or subfield 424 which may be set to values ACCEPT, DECLINE, MODIFY, etc. The Status field 424 set to ACCEPT may be used to indicate that the AP accepts the parameters carried by the LLTI Request frame 511 sent by STA1. Status field 424 set to DECLINE may be used to indicate that the AP rejects the LLTI transmission from STA1. Status field 424 set to MODIFIED may be used to indicate that the AP suggests a new set of parameter values for the LLTI transmission.

In exemplary embodiments, Status field 309 and/or subfield 424 may be used to indicate Status in LLTI Response frame 521.

In exemplary embodiments, the LLTI-related parameters may optionally be present in LLTI Response frame 521 depending on the setting of the Status field 424. For example, the LLTI parameters may not be present when the Status field 424 is set to ACCEPT or DECLINE.

In exemplary embodiments, the AP may transmit the LLTI Response frame 521 in an unsolicited way to announce the update or termination of the LLTI parameters.

It should be noted that in the exemplary procedure of FIG. 5, Type field 308 is carried in LLTI element 300. In other embodiments, Type field 308 may be carried directly in the LLTI Request/Response frame 400.

In exemplary LLTI negotiation procedures, different STAs may request and/or be granted different LLTI parameters based on each STA's low latency traffic flow characteristics. In other words, in the procedure depicted in FIG. 5, LLTI Request 511 from STA1 may have LLTI-related parameters different than those in LLTI Request 512 from STAm. Additionally, LLTI Response 521 sent by the AP for STA1 may have different LLTI-related parameter values than those in LLTI Response 522 sent by the AP for STAm.

A STA (whether or not an AP) may request or announce the termination of the accepted or agreed-upon LLTI parameters. The STA may do so by sending an LLTI Request frame with Type field 308 set to REMOVE.

### LLTI Negotiation Using Existing SCS Procedure

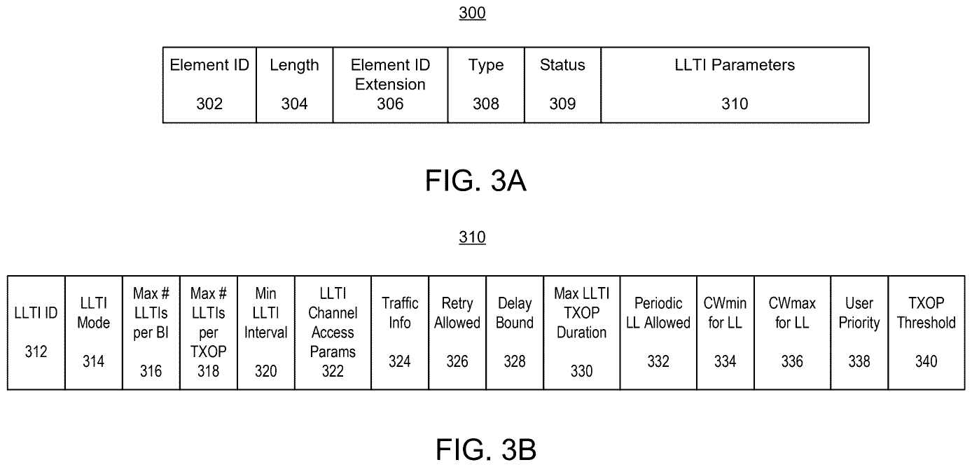

In exemplary embodiments, LLTI element 300 may be added to an existing frame or element. For example, the Stream Classification Service (SCS) procedure, as defined in IEEE Std 802.11™-2020-REVme™/D7.0: Wireless LAN Medium Access Control (MAC) and Physical Layer (PHY) Specifications, may be modified, with frames used therein carrying one or more LLTI elements or one or more fields of LLTI element 300, such as those described above. An exemplary LLTI negotiation procedure will now be described with reference to FIG. 6.

A non-AP STA, STA1, that supports SCS may acquire the wireless medium, such as through CSMA/CA, EDCA, or any other suitable channel access method in accordance with WiFi standards. In exemplary embodiments, the non-AP STA1 may be polled or triggered by an AP to transmit on the wireless medium. As shown in FIG. 6, STA1 sends an SCS Request frame 611 which includes one or more LLTI elements 300 or one or more fields of an LLTI element 300. The parameters carried in the LLTI element 300 may be parameters suggested by the non-AP STA to the AP for the traffic flow/SCS stream identified by the SCSID included in the SCS Request frame 611. In exemplary embodiments, after the SCS Request/Response frames have been successfully exchanged and SCS parameters accepted, the non-AP STA may transmit a frame with an existing SCSID and suggested LLTI parameters to indicate the application of the LLTI parameters to the stream flow identified by the SCSID.

Responsive to reception of the SCS Request frame 611, the AP may respond with a SCS Response frame 621. If the SCS Request frame 611 carries LLTI element 300 or one or more fields thereof, SCS Response frame 621 may carry one or more of the following fields:
An LLTI Status Code field: This may be a newly defined status field, which may be set to a value of: (i) SUCCESS, if the AP accepts the LLTI parameters for the requested SCSID; (ii) DECLINED, if the AP declines the LLTI parameters for the requested SCSID; or (iii) MODIFIED, if the AP modifies the LLTI parameters for the requested SCSID. The modified LLTI parameters may be included in SCS Response frame 621.
In exemplary embodiments, the existing Status field carried in the SCS Response frame may be used to indicate whether the AP accepts or declines the SCS stream and the LLTI parameters associated with the SCS stream.
In exemplary embodiments, the AP may, without solicitation, transmit SCS Response frame 621 to announce the update or termination of the LLTI parameters.

Once the AP has sent a SCS Response frame 621 that indicates the acceptance of the SCS and LLTI parameters or includes LLTI parameters determined by the AP, the STA1 receiving SCS Response frame 621 is thus allowed to use LLTI channel access as defined by the LLTI parameters to send its corresponding traffic flow/SCS stream.

As with the LLTI negotiation procedure of FIG. 5, different STAs may request and/or be granted different LLTI parameters. In other words, in the procedure depicted in FIG. 6, SCS Request 611 from STA1 may indicate LLTI-related parameters different than those in SCS Request 612 from STAm. Additionally, SCS Response 621 sent by the AP for STA1 may have different LLTI-related parameter values than those in SCS Response 622 sent by the AP for STAm.

### Broadcast of the LLTI Element

In exemplary embodiments, the AP may include the LLTI element 300 in a broadcast frame, such as a Beacon frame. For potential LLTI transmissions, the parameters carried in the LLTI element may apply to any STA receiving the Beacon frame. Non-AP STAs may choose their LLTI-related parameters based on the information carried in the LLTI element. For example, LLTI channel access may be allowed only for those traffic flows which meet the requirements in the LLTI element. In exemplary embodiments, the non-AP STAs may report to the AP that they have traffic flows that qualify for LLTI channel access and intend to use LLTI channel access.

### Score-Based Channel Access

In exemplary embodiments, a low latency score (LL score) is assigned to a traffic flow or a SCS stream to indicate the urgency of the stream's low latency requirements. For example, a stream with more urgent, or tighter, latency requirements (e.g., short delay/jitter, short delay bound) may be assigned a higher LL score than a stream with less urgent, or looser, latency requirements. Based on the LL score, a STA may choose LLTI channel access parameters according to a predefined rule. The LL score can thus be thought of as being used as an intermediate index which associates a traffic flow with latency requirements and LLTI channel access parameters. As further described below, the LL score may be used to indicate groups of traffic flows with similar characteristics, and to map them to sets of LLTI channel access parameter values.

In exemplary embodiments, the LL score may be assigned deterministically. In such embodiments, the LL score assign to a traffic flow may be based on one or more values related to a QoS requirement, user priority, and/or other parameters related to traffic flow, such as latency and/or jitter requirements. For example, the LL score may be based on the delay bound, user priority value, MSDU lifetime, and/or DL/UL traffic, etc. The mapping between the LL score and the corresponding parameters is specified and fixed so that any STA can know the score of a traffic flow.

In exemplary embodiments, the LL score may be assigned dynamically. In such embodiments, the LL score assignment may depend on network conditions, QoS requirements, user priority, and/or other parameters related with traffic flow, such as latency/jitter requirements. For example, for the same type of traffic flow, the AP may assign a lower LL score when the network is busy (e.g., there is a large volume of traffic buffered and waiting for transmission, a large number of STAs contending for the wireless medium, etc), than it would when the network is not as busy. The AP and the STA may negotiate the LL score assignment and the AP may adjust the assigned LL score from time to time. Advantageously, the AP may use the score assignment to control channel access and network congestion.

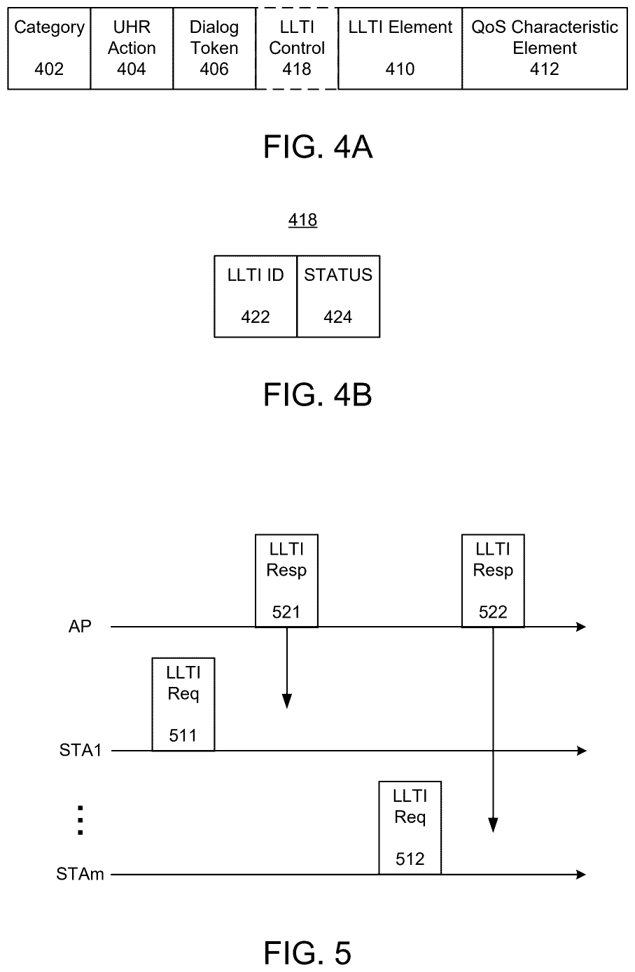

An exemplary dynamic LL score assignment procedure in which the AP and a STA negotiate the LL score assignment will now be described with reference to FIG. 7. As shown, STA1 transmits an LL Score Request frame 711, which includes information about traffic flow with low latency requirement, user priority, etc. In exemplary embodiments, frame 711 may include an LLTI element 300, a QoS Characteristic element 412, and/or one or more fields defined for said elements. The STA may also include in the LL Score Request frame 711 a suggested LL score for the associated traffic flow. The STA may also include an identity for the traffic flow (e.g., LL ID) which the AP may use in an LL Score Response frame 721 to identify the traffic flow. The AP may respond with an LL Score Response frame 721 which may include the LL ID and/or the main characteristics of the traffic flow. The AP may assign an LL Score to the traffic flow based on the characteristics of the traffic flow, the user priority, and/or the network condition. The AP may include the assigned LL score in LL Score Response frame 721.

As depicted in FIG. 7, the LL score assignment procedure may be carried out independently between the AP and different STAs, such as STAm, which may send its own LL Score Request frame 712, responsive to which the AP may send LL Score Response frame 722, with an assigned LL score different than that sent in frame 721 to STA1.

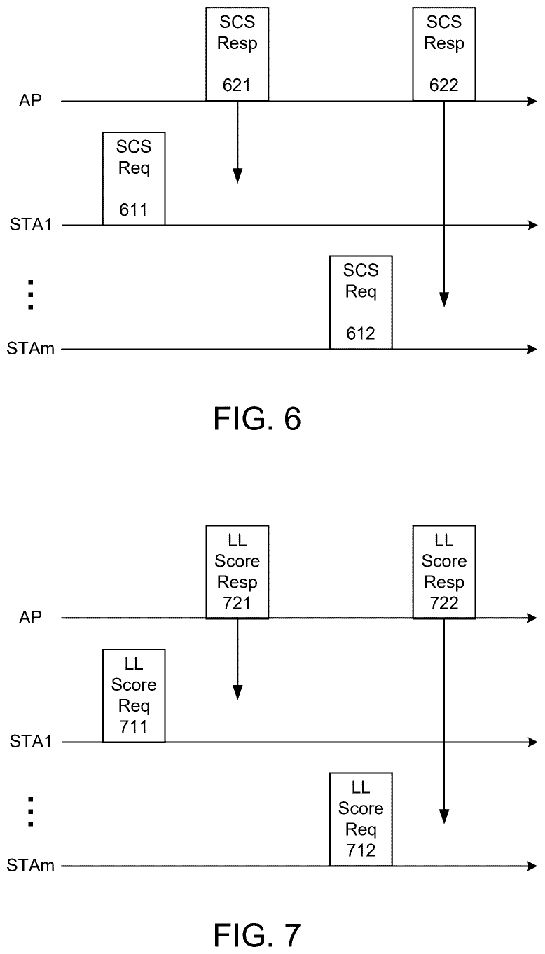

Referring now to FIG. 8, in exemplary embodiments, based on network conditions, the AP may broadcast LL Score assignment criteria, such as in a Beacon frame 801, 802 or a newly defined frame. As one example, traffic flows with delay bound of x (or less) microseconds, UL (or DL) direction, and user priority of y or greater, may be assigned an LL score of 1. Once the AP has thusly announced a set of criteria for LL score assignment, the non-AP STAs, STA1-STAm, associated with the AP may use the criteria to respectively set the LL score for their qualified traffic flows. The non-AP STAs may respectively report their LL scores to the AP in an LL Score Report frame 811, 812, which may be, for example, a UL frame (e.g., ACK/BA frame or a newly defined frame), or a MAC header of a UL frame. The AP may announce a new set of criteria as needed, such as in a subsequent Beacon frame 802. The non-AP STAs may use the current criteria until they receive a new set of criteria. After the LL score assignment, the AP and STA may commence LLTI channel access, which may be used to transmit an LLTI PPDU and/or PPDU(s) carrying the low latency traffic.

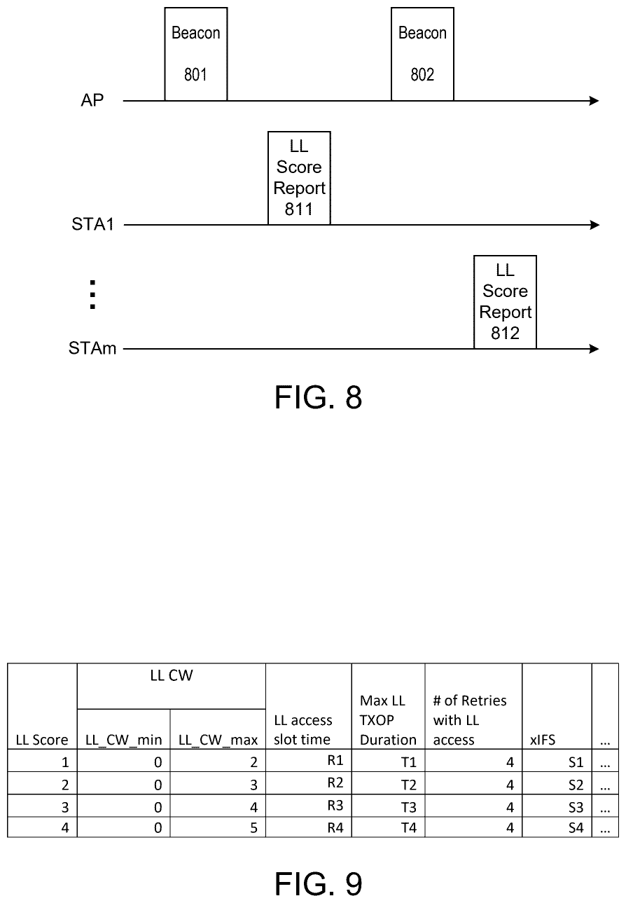

Once an AP and a STA have reached agreement on an LL score assignment for a traffic flow or SCS stream, the LL score may be used to choose LL channel access parameters. In exemplary embodiments, an LL score may be mapped to one or a set of LL channel access related parameters. A non-AP STA which has a low latency traffic flow may determine the LL score of the traffic flow, determine the set of LL channel access related parameters to which the LL score maps, and use the parameters for channel access if the channel access is approved or granted by the AP. In exemplary embodiments, an LL score may be mapped to an existing AC or TID and the channel access parameters linked to that AC or TID may be used for LL channel access. FIG. 9 shows an exemplary mapping of the LL Score to a set of LL channel access parameters. In this example, the lowest LL Score corresponds to a traffic flow with the most urgent latency requirement. One or more columns defined in FIG. 9 may be the related LL channel access parameters used for low latency channel access.

For example, LL_CW_min and LL_CW_max may be used to set the minimum and maximum values, respectively, of the contention window, LL CW, for low latency channel access, as described above with respect to fields 334 and 336 of element 300. A STA which has LL traffic with an LL Score may start a backoff counter in the range of [0, LL CW] for the initial LLTI transmission, with the LL CW determined in accordance with the LL Score, as shown in FIG. 9. The LL CW may be set to LL_CW_min initially and for retransmission, the LL CW may be increased up to LL_CW_max in accordance with a predefined function. The backoff counter may be decremented by 1 for each LL access slot time. In exemplary embodiments, the LL access slot time may be the aSlotTime defined in IEEE Std 802.11™-2020-REVme™/D7.0: Wireless LAN Medium Access Control (MAC) and Physical Layer (PHY) Specifications, or it may be a newly defined slot time, designated, for example, aLLSlotTime. In exemplary embodiments, the LL access slot time may be determined by the LL Score, as shown in FIG. 9.

After the backoff counter has decremented from its initial value down to 0, the STA may transmit the LLTI. If the STA re-transmits the LLTI for some reason (e.g., because the LLTI transmission collided, the STA failed to receive a responding/acknowledgement frame, by default to avoid LLTI transmission collision, etc.), the STA may increase its LL CW value using a function, such as for example, LL CW=min(LL CW+1, LL_CW_max), and randomly pick an initial value of the backoff counter in the range of [0, LL CW]. The number of retries for the LLTI transmission is capped by the Number of Retries with LL access value defined in the mapping shown in FIG. 9. A STA in the process of an LLTI transmission may pause its transmission if it detects another LLTI transmission or a transmission with energy greater than a predefined threshold.

A STA may acquire the wireless medium based on certain criteria. For example, the STA may receive a response frame or an acknowledgement frame from its responder, or the STA may successfully transmit the LLTI N times continuously. In one method, N may be a fixed value and specified in the specification. In one method, N may be a value chosen by the AP and announced in an element (e.g., in LLTI element 300, field 326) and/or in a broadcast/unicast management frame, action frame, etc.

As shown in FIG. 9, xIFS may be a parameter for an inter-frame spacing used in the LL channel access that is determined in accordance with LL Score. Max LL TXOP Duration, which may be defined as the maximum TXOP duration the STA may set when the TXOP is acquired by LL channel access, may also be determined in accordance with LL Score.

In addition to the above-described uses, the LL score may be used in cases in which a TID or SCSID is used to identify a corresponding traffic flow. For example, an LL score may be included in a Trigger frame (e.g., in an LL Score field in the Trigger Dependent User Info field) to indicate that the traffic flow with the LL score is triggered for transmission. In another example, an LL score may be used in buffer status reporting. An LL Score field may be included in the Buffer Status Report (BSR) Control field of the High Throughput (HT) Control field of the MAC header of a frame, to allow a STA to report the queue size of the traffic flow corresponding to the LL Score. In another example, an LL score may be used in QoS reporting. An LL Score field may be included in the QoS Control field in the MAC header of a frame. When the both the LL Score field and Queue Size field are carried in the QoS Control field, the Queue Size field may indicate the amount of buffered traffic for a traffic flow corresponding to the LL score.

### LLTI Channel Access Start and End Control

After any negotiations between an AP and a non-AP STA regarding LLTI channel access, including, for example, any exchanges of LLTI Request/Response frames (as depicted in FIG. 5), SCS Request/Response frames (as depicted in FIG. 6), and/or LL Score Request/Response frames (as depicted in FIG. 7), the AP and the non-AP STA may agree to use LLTI channel access with a set of LLTI parameters for the corresponding traffic flows or SCS streams. In exemplary embodiments, the AP and STA may start LLTI channel access immediately.

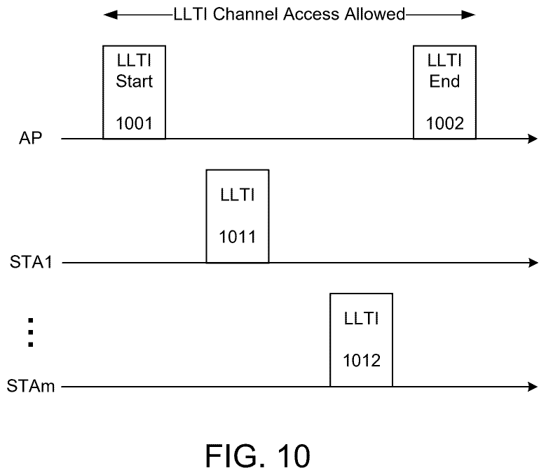

Turning now to FIG. 10, in exemplary embodiments, the AP may announce that LLTI channel access is allowed during a period of time by transmitting an LLTI Start frame 1001 and an LLTI end frame 1002. Any non-AP STAs which engaged in LLTI channel access negotiation with the AP may use LLTI channel access during the period defined by the Start and End frames 1001, 1002. The LLTI Start frame 1001 and LLTI End frame 1002 may be newly defined management frames, action frames, or control frames. In exemplary embodiments, the AP may announce the start and the end of, or the start and the duration of, an LLTI channel access period in the LLTI Start frame 1001, in which case the LLTI End frame 1002 can be omitted. Optionally, the AP may terminate the LLTI channel access period earlier than indicated, such as by sending an LLTI End frame 1002 before the end indicated in the LLTI Start frame 1001. In exemplary embodiments, the AP may announce the start, end, and/or duration of an LLTI channel access period in a broadcast/multicast manner, such as in a Beacon frame or other management/action/control frame.

While this disclosure refers to “low latency traffic,” the methods and apparatuses disclosed herein are not limited to low latency traffic but may also be implemented for other types of high priority traffic, traffic for which it may be necessary or desirable to provide high priority transmission, or transmission of a higher priority than non-high priority traffic. As such for example, an indication such as the LLTI described above that can be used for high priority traffic may be referred to as a high priority traffic indication (HPTI) or an indication of high priority traffic, containing some or all of the same information or equivalents thereof as the LLTI.

Various numeric values are used in the present disclosure. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc. Use of such terms does not imply an ordering to the modified operations unless specifically required. So, in this example, a first operation need not be performed before a second operation, and may occur, for example, before, during, or in an overlapping time period with the second operation.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information may include one or more of, for example, estimating the information, calculating the information, predicting the information, or retrieving the information from memory.

Further, this disclosure may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this specific implementation and are applicable to other wireless systems as well.

Although SIFS may be used to indicate various inter-frame spacing in the examples of the designs and procedures, all other inter-frame spacing such as RIFS, AIFS, DIFS or other agreed time interval could be applied in the same solutions. A Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Examples, without limitation, of embodiments as contemplated by the present disclosure are set forth in the following clauses.

Clause 1: a method for a Station (STA), comprising: transmitting, to an access point (AP), a request frame including information for managing high priority traffic over a wireless medium in a Wireless Local Area Network (WLAN) comprising a type and an identifier (ID) that indicates channel access information for managing the high priority traffic; and receiving, from the AP, a response frame based on the type and the ID.

Clause 2: the method of clause 1, wherein the channel access information indicated by the ID comprises values corresponding to low latency traffic Indicator (LLTI) channel access parameters.

Clause 3: the method of clause 1 or 2, wherein the information comprises a low latency traffic Indicator (LLTI) element including fields for indicating the channel access information.

Clause 4: the method of clause 1, 2, or 3, wherein based on the type being set to request, the ID indicates new parameter values of the channel access information for managing the high priority traffic.

Clause 5: the method of any of clauses 1 through 4, wherein based on the type being set to update, the ID indicates one or more updated parameter values of the channel access information for managing the high priority traffic.

Clause 6: the method of any of clauses 1 through 5, wherein based on the type being set to response, the received response frame includes parameters of the channel access information for managing the high priority traffic.

Clause 7: the method of clause 6, wherein the response frame comprises a status field that indicates one of an approval, denial, or modification of the parameters of the channel access information for managing the high priority traffic.

Clause 8: a Station (STA) comprising a transceiver and a processor communicatively coupled to the transceiver, the transceiver and processor being configured to: transmit, to an access point (AP), a request frame including information for managing high priority traffic over a wireless medium in a Wireless Local Area Network (WLAN) comprising a type and an identifier (ID) that indicates channel access information for managing the high priority traffic; and receive, from the AP, a response frame based on the type and the ID.

Clause 9: the STA of clause 8, wherein the channel access information indicated by the ID comprises values corresponding to low latency traffic Indicator (LLTI) channel access parameters.

Clause 10: the STA of clause 8 or 9, wherein the information comprises a low latency traffic Indicator (LLTI) element including fields for indicating the channel access information.

Clause 11: the STA of clause 8, 9, or 10, wherein based on the type being set to request, the ID indicates new parameter values of the channel access information for managing the high priority traffic.

Clause 12: the STA of any of clauses 8 through 11, wherein based on the type being set to update, the ID indicates one or more updated parameter values of the channel access information for managing the high priority traffic.

Clause 13: the STA of any of clauses 8 through 12, wherein based on the type being set to response, the received response frame includes parameters of the channel access information for managing the high priority traffic.

Clause 14: the STA of clause 13, wherein the response frame comprises a status field that indicates one of an approval, denial, or modification of the parameters of the channel access information for managing the high priority traffic.

1. A method for a station (STA), the method comprising:
transmitting, to an access point (AP), a request regarding one or more conditions for managing low latency traffic access to a wireless medium in a wireless local area network (WLAN);
receiving, from the AP, a response including management information relating to the one or more conditions; and
accessing the wireless medium in accordance with the management information.

2. The method of claim 1, wherein the request includes one or more parameter values suggested by the STA relating to the one or more conditions.

3. The method of claim 2, wherein the management information includes status information including an indication that the one or more parameter values suggested by the STA are declined, accepted, modified, or removed.

4. The method of claim 1, wherein the management information includes a set of parameter values determined by the AP.

5. The method of claim 1, wherein the request includes a low latency traffic indication (LLTI) request action frame and the response includes an LLTI response action frame.

6. The method of claim 1, wherein the request includes a Stream Classification Service (SCS) request frame and the response includes an SCS response frame.

7. The method of claim 1, wherein the request includes a low latency (LL) score request frame and the response includes an LL score response frame.

8. The method of claim 7, wherein:
at least one of the LL score request frame or the LL score response frame includes an LL score determined deterministically or dynamically, and
the LL score is associated with one or more access parameters.

9. The method of claim 8, wherein the LL score is determined using criteria announced by the AP in a beacon frame or other broadcasted frame.

10. (canceled)

11. The method of claim 1 comprising receiving from the AP an indication of a time period in which low latency traffic access of the wireless medium is allowed, wherein the STA accesses the wireless medium during the time period.

12. A station (STA) comprising:
a transceiver and a processor communicatively coupled to the transceiver, the transceiver and processor configured to:
transmit, to an access point (AP), a request regarding one or more conditions for managing low latency traffic access to a wireless medium in a wireless local area network (WLAN);
receive, from the AP, a response including management information relating to the one or more conditions; and
access the wireless medium in accordance with the management information.

13. The STA of claim 12, wherein the request includes one or more parameter values suggested by the STA relating to the one or more conditions.

14. The STA of claim 13, wherein the management information includes status information including an indication that the one or more parameter values suggested by the STA are declined, accepted, modified, or removed.

15. The STA of claim 12, wherein the management information includes a set of parameter values determined by the AP.

16. The STA of claim 12, wherein the request includes a low latency traffic indication (LLTI) request action frame and the response includes an LLTI response action frame.

17. The STA of claim 12, wherein the request includes a Stream Classification Service (SCS) request frame and the response includes an SCS response frame.

18. The STA of claim 12, wherein the request includes a low latency (LL) score request frame and the response includes an LL score response frame.

19. The STA of claim 18, wherein:
at least one of the LL score request frame or the LL score response frame includes an LL score determined deterministically or dynamically, and
the LL score is associated with one or more access parameters.

20. The STA of claim 19, wherein the LL score is determined using criteria announced by the AP in a beacon frame or other broadcasted frame.

21. (canceled)

22. The STA of claim 12, wherein the transceiver and processor are configured to:
receive from the AP an indication of a time period in which low latency traffic access of the wireless medium is allowed, and
access the wireless medium during the time period.
